(19) United States
(12) Patent Application Publication
(10) Pub. No.: US 2017/0168615 A1
(43) Pub. Date: Jun. 15, 2017

(54) Display device and control device thereof

(71) Applicant: NOVATEK Microelectronics Corp., Hsin-Chu (TW)

(72) Inventor: Ying-Neng Huang, Taichung City (TW)

(21) Appl. No.: 14/970,489

(22) Filed: Dec. 15, 2015

(51) Int. Cl. G06F 3/041; G06F 3/042; G09G 3/20; H04N 5/357; H04N 5/378; G06K 9/00

(52) U.S. Cl. CPC G06F 3/0412; H04N 5/378; G06K 9/00013; G09G 3/2096; H04N 5/3575; G06F 3/0425; G09G 2310/0286; G09G 2310/0289; G09G 2310/0291; G09G 2310/08

(57) ABSTRACT

A control device for a panel with display and sensing functions includes a plurality of channel terminals and a plurality of control units. The plurality of channel terminals are coupled to the panel. Each of the plurality of control units is coupled to one of the plurality of channel terminals, and configured to selectively generate a display signal to be transmitted to the panel via the channel terminal and generate image sensing data based on a sensing signal received from the panel via the channel terminal.

### BACKGROUND OF THE INVENTION

1. Field of the Invention

The present invention relates to a display device, and more particularly, to a display device having display and sensing functions and a control device thereof.

2. Description of the Prior Art

With advancements in technology, mobile devices such as smart phones, tablets, laptops, GPS navigation systems and electronic books have become indispensable in our daily life. Compared with conventional mobile phones that only have communication functions, modern mobile devices combine various functions such as communication, networking, photographing, games and data processing. This type of multifunctional design is more attractive to consumers. Fingerprint recognition is a popular function for security and privacy in various electronic devices, including mobile devices, and can be implemented in different techniques such as capacitance sensing, optical (image sensing), thermal, ultrasonic, etc. For example, a mobile phone may have a fingerprint recognition interface built into a home button or in a dedicated region to detect user fingerprint.

In general, for an electronic device equipped with both a display panel and a fingerprint recognition interface, the display panel and the fingerprint recognition interface are separate components, and also the sensing circuits of the fingerprint recognition interface and display driving circuits of the display panel are implemented indifferent circuits or modules. This increases the complexity of the device structure and also restricts the area capable of receiving fingerprint input.

### SUMMARY OF THE INVENTION

It is therefore an objective of the present invention to provide a display device having display and sensing functions and a control device thereof. A panel of the display device, which is capable of data display and image sensing functions, can be extended throughout an entire surface of the display device where the usage of any additional buttons may be omitted. This benefits the mechanical design of the display device and thereby reduces the cost.

The present invention discloses a control device for a panel with display and sensing functions. The control device comprises a plurality of channel terminals and a plurality of control units. The plurality of channel terminals are coupled to the panel. Each of the plurality of control units is coupled to one of the plurality of channel terminals, and configured to selectively generate a display signal to be transmitted to the panel via the channel terminal and generate image sensing data based on a sensing signal received from the panel via the channel terminal.

The present invention further discloses a display device, which comprises a panel and a control device. The panel has display and sensing functions and is used for receiving a display signal and generating a sensing signal. The control device includes a plurality of channel terminals and a plurality of control units. The plurality of channel terminals is coupled to the panel. Each of the plurality of control units is coupled to one of the plurality of channel terminals, and configured to selectively generate the display signal to be transmitted to the panel via the channel terminal and generate image sensing data based on the sensing signal received from the panel via the channel terminal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display device according to related art.

FIG. 2 is a schematic diagram of an image sensing device according to related art.

FIG. 3 is a schematic diagram of a readout circuit of an image sensing device according to an embodiment of the present invention.

FIG. 4 is a schematic diagram of a control device with display and sensing functions according to an embodiment of the present invention.

FIGS. 5A and 5B are diagrams of a deployment of display area and image sensing area according to embodiments of the present invention.

FIG. 6 is a schematic diagram of a display device having image sensing and display functions according to an embodiment of the present invention.

FIGS. 7A and 7B are schematic diagrams of configurations of the operation modes of the control units of a control device according to an embodiment of the present invention.

FIG. 8 is a schematic diagram of another control device according to an embodiment of the present invention.

FIGS. 9A and 9B are schematic diagrams of configurations of the operation modes of the control units of a control device according to an embodiment of the present invention.

### DETAILED DESCRIPTION

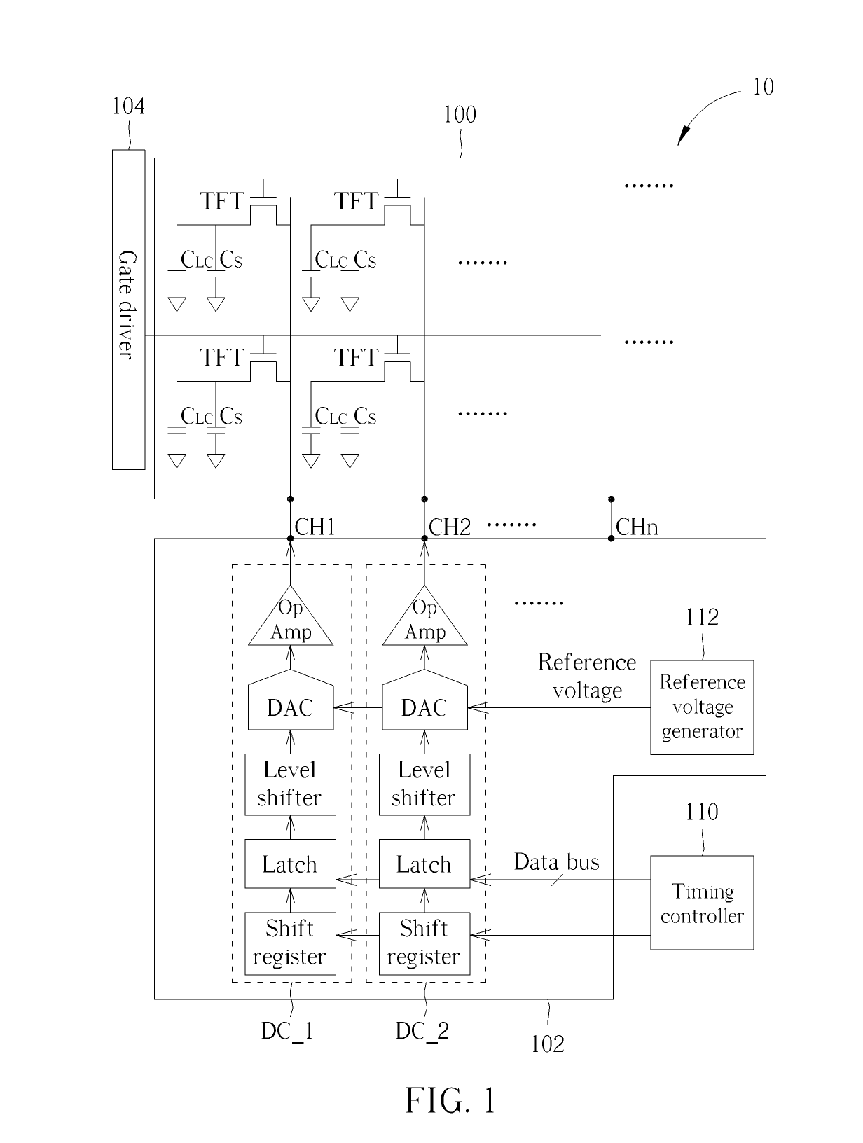

Please refer to FIG. 1, which is a schematic diagram of a display device 10 according to related art. As shown in FIG. 1, the display device 10 includes a display panel 100, a source driver 102, a gate driver 104 and a timing controller 110. The display panel 100 includes a plurality of pixels arranged in an array, where each display pixel includes a thin-film transistor (TFT), a liquid crystal capacitor C_{LC} and a storage capacitor C_{S}, for receiving and storing display data from the source driver 102. The source driver 102 includes a reference voltage generator 112 and a plurality of data driving units DC_1-DC_N. The timing controller 110 is used for transmitting display data to the data driving units DC_1-DC_N via data buses connected between the timing controller 110 and the data driving units DC_1-DC_N, and controlling the operations of the data driving units DC_1-DC_N. The timing controller 110 may be implemented in an independent integrated circuit (IC) or integrated with the source driver 102. The reference voltage generator 112 is used for providing reference voltages for the data driving units DC_1-DC_N. For example, the reference voltage generator 112 may be a gamma generator that generates gamma voltages for digital-to-analog converters in the data driving units DC_1-DC_N.

In addition, the data driving units DC_1-DC_N are coupled to the display panel 100 via a plurality of channel terminals CH1-CHn, respectively, where each of the data driving units DC_1-DC_N is coupled to a corresponding channel terminal among the channel terminals CH1-CHn. Each of the data driving units DC_1-DC_N includes an operational amplifier, a digital-to-analog converter (DAC), a level shifter, a latch circuit and a shift register. The shift register, which is coupled to the latch circuit, is used for controlling the operations of the latch circuit according to a timing sequence received from the timing controller 110. The latch circuit is used for storing the display data transmitted from the timing controller 110 via the data buses and delivering the display data according to the control of the shift register. The level shifter, coupled to the latch circuit, is used for shifting the voltage level of the display data transmitted from the latch circuit. The DAC, coupled to the level shifter, then converts the display data in digital form into a display signal in analog form. The operational amplifier, coupled to the DAC, is used as a voltage buffer for transmitting the display signal to drive the display panel 100. In this manner, the display signal is transmitted to a target display pixel of the display panel 100 to be displayed. The gate driver 104 may turn on the TFT of the target display pixel, allowing the display pixel to receive the display signal. The gate driver 104 may be a gate driver IC or a gate-on-array (GOA) structure implemented on a glass substrate of the display panel 100. The operations of the gate driver 104 may be controlled by the timing controller 110.

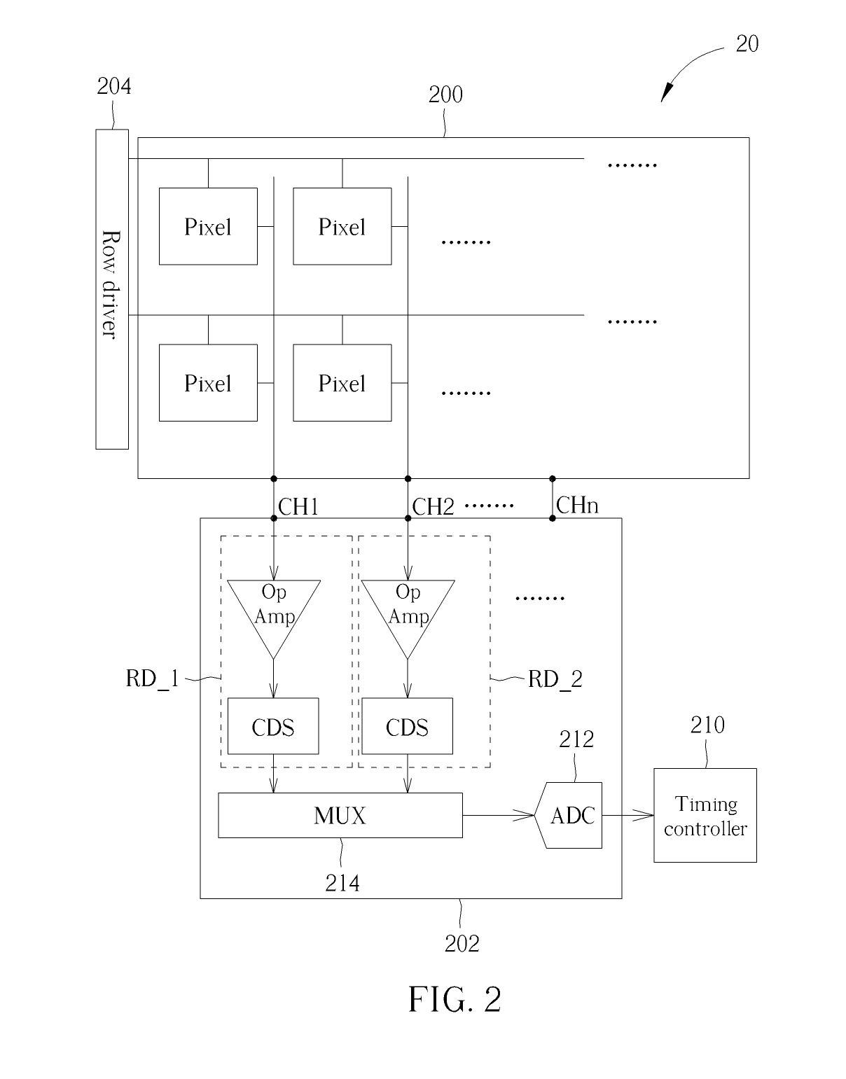

Please refer to FIG. 2, which is a schematic diagram of an image sensing device 20 according to related art. As shown in FIG. 2, the image sensing device 20 includes a detector panel 200, a readout circuit 202, a row driver 204 and a timing controller 210. The detector panel 200 includes a plurality of pixels arranged in an array of columns and rows, and the circuitry of each pixel includes transistors, a storage capacitor and a photodiode, which are well known to those skilled in the art and omitted herein. Each pixel of the detector panel 200 may sense the ambient light and convert to a current signal according to the received light intensity, and generate an image sensing signal, so as to realize fingerprint recognition. The row driver 204 may turn on transistors of a row of pixels such that the readout circuit 202 receives the image sensing signals from the row of pixels.

The readout circuit 202 includes an analog-to-digital converter (ADC) 212, a multiplexer (MUX) 214 and a plurality of readout units RD_1-RD_N. The readout units RD_1-RD_N are coupled to the detector panel 200 via a plurality of channel terminals CH1-CHn, respectively. Each of the readout units RD_1-RD_N is coupled to a corresponding column of pixels of the detector panel 200 via a corresponding channel terminal among the channel terminals CH1-CHn. Each of the readout units RD_1-RD_N includes an operational amplifier and a correlated double sampling (CDS) circuit. The operational amplifier is used for receiving and amplifying the sensing signal from the detector panel 200. The CDS circuit, coupled to the operational amplifier, is used for reducing noises in the sensing signal after receiving the sensing signal from the operational amplifier. The MUX 214 is coupled to the readout units RD_1-RD_N and selectively forwards one of the sensing signals to the ADC 212. In detail, the MUX 214 may receive the sensing signals from the readout units RD_1-RD_N in parallel, store the sensing signals in the buffers, and then transmit the sensing signals to the ADC 212 in series. The ADC 212, coupled to the MUX 214, is used for converting the sensing signals in analog form into image sensing data in digital form. The timing controller 210 then receives the image sensing data from the ADC 212. The timing controller 210 controls the operations of the row driver 204 and the readout circuit 202 so as to receive the image sensing data accordingly.

According to an embodiment of the present invention, the operations of the source driver 102 of the display device 10 and the readout circuit 202 of the image sensing device 20 may be integrated for being capable of receiving the image sensing signal from a panel and driving the panel to display data. That panel can be integrated by the display panel 100 and the detector panel 200 to realize both display and image sensing functions. The channel terminals, as the interface connecting the integrated circuit (of the source driver 102 and the readout circuit 202) and the panel, are used for transmitting both the display signals and sensing signals. In other words, the display and image sensing operations in an electronic device may share the same panel, and also share the same channel terminals and control circuits.

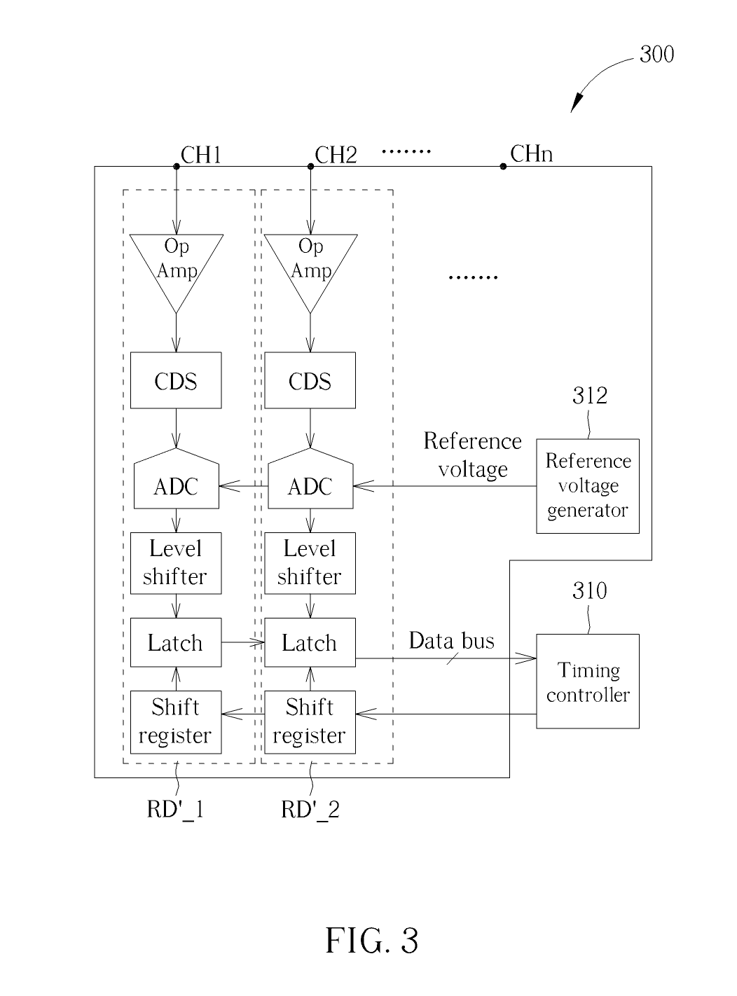

In order to integrate the circuit structures of the data driving units DC_1-DC_N shown in FIG. 1 and the readout units RD_1-RD_N shown in FIG. 2, the readout units RD_1-RD_N may be modified to have a circuit structure similar to the data driving units DC_1-DC_N. Please refer to FIG. 3, which is a schematic diagram of a readout circuit 300 according to an embodiment of the present invention. Similar to the readout circuit 202 of FIG. 2, the readout circuit 300 also includes a plurality of readout units RD′_1-RD′_N. The structure of the readout units RD′_1-RD′_N is modified from the readout units RD_1-RD_N of FIG. 2 while the functions of the readout units RD_1-RD_N still remain. The readout units RD′_1-RD′_N are coupled to a corresponding detector panel via a plurality of channel terminals CH1-CHn, respectively, where each of the readout units RD′_1-RD′_N is coupled to a corresponding channel terminal among the channel terminals CH1-CHn. The readout circuit 300 is coupled to a timing controller 310, which receives the image sensing data from the readout units RD′_1-RD′_N. The readout circuit 300 further includes a reference voltage generator 312 for providing reference voltages. The timing controller 310 may be implemented in an independent IC or integrated with the readout circuit 300 in an IC.

Each of the readout units RD′_1-RD′_N includes an operational amplifier, a CDS circuit, an ADC, a level shifter, a latch circuit and a shift register. The functions and circuit structures of the operational amplifier and the CDS circuit are the same as those in the readout circuit 202. That is, the operational amplifier transmits the sensing signal and the CDS circuit reduces noises in the sensing signal. The ADC in the readout units RD′_1-RD′_N has similar functions as the ADC 212 in the readout circuit 202, which converts the sensing signals in analog form into image sensing data in digital form. The only difference is that the ADC shown in FIG. 3 is deployed in every readout unit of the readout units RD′_1-RD′_N for converting the sensing signals. The level shifter, coupled to the ADC, is used for shifting the voltage level of the image sensing data transmitted from the ADC. The shift register, which is coupled to the latch circuit, is used for controlling the operations of the latch circuit according to a timing sequence received from the timing controller 310. Therefore, the latch circuit may store the image sensing data transmitted from the level shifter and deliver the image sensing data to the timing controller 310 via the data buses according to the control of the shift register.

As can be seen in FIGS. 1 and 3, the data driving units DC_1-DC_N and the readout units RD′_1-RD′_N include similar functional blocks and are easily combined. More specifically, the operational amplifier, the level shifter, the latch circuit and the shift register exist in both of the data driving units DC_1-DC_N and the readout units RD′_1-RD′_N. The readout units RD′_1-RD′_N differs from the data driving units DC_1-DC_N in that the readout units RD′_1-RD′_N further include CDS circuits and that the readout units RD′_1-RD′_N use the ADCs to convert the signal format from analog to digital while the data driving units DC_1-DC_N use the DACs to convert the signal format from digital to analog. In addition, the direction of signal transmission is different in the data driving units DC_1-DC_N and the readout units RD′_1-RD′_N, so the functional blocks should be able to selectively transmit the data or signals in different directions.

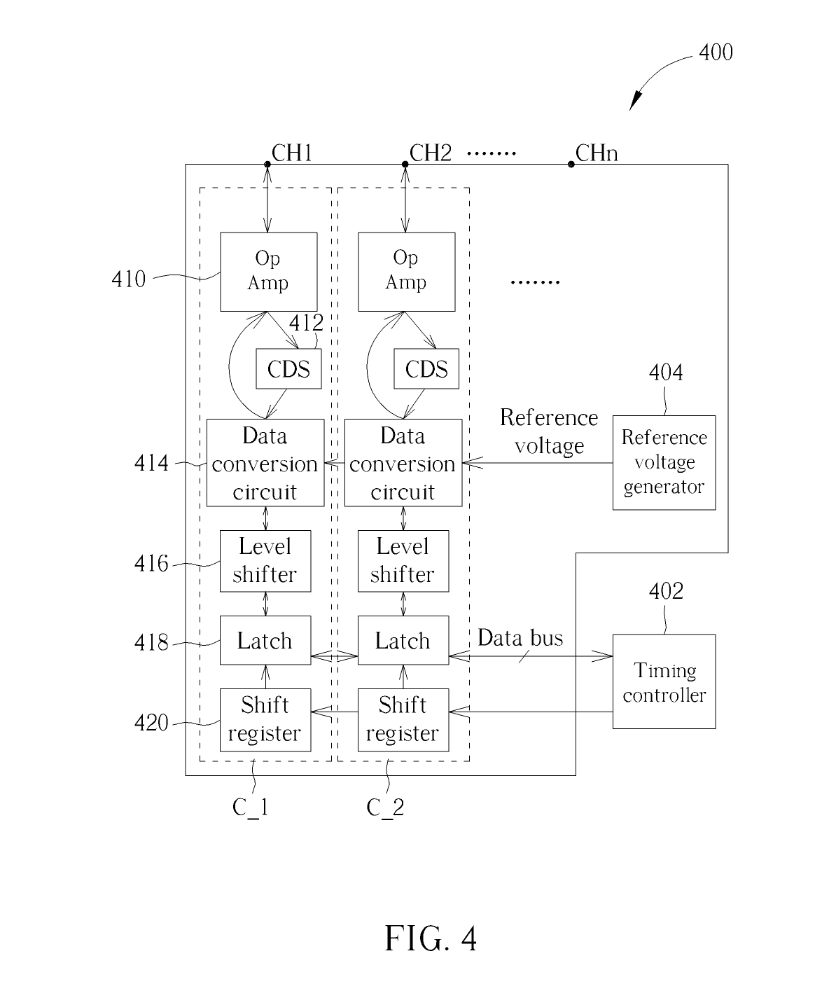

Please refer to FIG. 4, which is a schematic diagram of a control device 400 according to an embodiment of the present invention. The control device 400, which is capable of display and sensing functions, includes a plurality of channel terminals CH1-CHn coupled to a panel and a plurality of control units C_1-C_N. Each of the control units C_1-C_N is coupled to one of the channel terminals CH1-CHn, and is configured to selectively generate a display signal to be transmitted to the panel via the corresponding channel terminal and generate image sensing data based on a sensing signal received from the panel via the corresponding channel terminal. In other words, the control units C_1-C_N may be operated in a driver mode or a readout mode selectively. In the driver mode, the control units C_1-C_N may transmit the display signal to the panel and drive the panel to display the display signal. In the readout mode, the control units C_1-C_N may receive the sensing signal from the panel and generate the image sensing data accordingly. The control device 400 further includes a reference voltage generator 404, and the control device 400 is coupled to a timing controller 402. The timing controller 402 may be an integrated circuit separate from the control device 400 or may be integrated with the control device 400. The timing controller 402 is used for transmitting display data to the control units C_1-C_N and receiving image sensing data from the control units C_1-C_N. The timing controller 402 may also control the operations of the control units C_1-C_N. The reference voltage generator 404 is used for providing reference voltages for the control units C_1-C_N. The reference voltage generator 404 may be a gamma generator that generates gamma voltages for the data conversion circuits in the control units C_1-C_N.

Please note that the control units C_1-C_N may selectively operate in the driver mode or the readout mode. More specifically, in the control device 400, the control units C_1-C_N may operate in the driver mode or the readout mode based on the control of the timing controller 402. For example, the control units C_1-C_N are configured to operate in the driver mode during a first period so as to generate display signals and to transmit the display signals to the panel via the channel terminals CH1-CHn. At another time, the control units C_1-C_N are configured to operate in the readout mode during a second period so as to receive sensing signals from the panel via the channel terminals CH1-CHn and to generate image sensing data based on the received sensing signals.

Please keep referring to FIG. 4. Each of the control units C_1-C_N includes an operational amplifier 410, a CDS circuit 412, a data conversion circuit 414, a level shifter 416, a latch circuit 418 and a shift register 420. Note that each of the control units C_1-C_N is a combination of a data driving unit shown in FIG. 1 and a readout unit shown in FIG. 3; hence, the circuit structure of each of the control units C_1-C_N has a part similar to a data driving unit of a source driver and has the other part similar to a readout unit of a readout device of an image sensing device. The operational amplifier 410 is used for selectively transmitting a display signal to drive the panel and receiving a sensing signal from the panel. More specifically, the operational amplifier 410 may transmit the display signal to drive the panel when operating in the driver mode, and may receive the sensing signal from the panel when operating in the readout mode. The CDS circuit 412, coupled to the operational amplifier 410, is used for reducing noises in the sensing signal after receiving the sensing signal from the operational amplifier 412. As shown in FIG. 4, the CDS circuit 412 is operated only in the readout mode by selective circuit paths. The data conversion circuit 414 is used for selectively converting the display data in digital form into the display signal in analog form in the driver mode, where the data conversion circuit 414 is operated as a DAC, and converting the sensing signal in analog form into the image sensing data in digital form in the readout mode, where the data conversion circuit 414 is operated as an ADC. The data conversion circuit 414 may receive reference voltages from the reference voltage generator 404 for data conversion. In an embodiment, the data conversion circuit 414 receives reference voltages when operating analog-to-digital conversion and operating digital-to-analog conversion. In this manner, the ADC and DAC operations may use the reference voltages and thereby share the same reference voltage generator 404 and the same transmission wires. Please note that an ADC or DAC requires many transmission wires for transmitting the reference voltages, so the sharing of transmission wires may lead to a significant reduction of transmission wires, and thus reduce the chip size and chip cost.

In addition, the level shifter 416, coupled to the data conversion circuit 414, is used for selectively shifting a voltage level of the display data and shifting a voltage level of the image data. More specifically, the level shifter 416 may shift the voltage level of the display data when operating in the driver mode, and shift the voltage level of the image sensing data in the readout mode. In general, the operational amplifier 410 should be operated in a higher voltage level in order to driver the panel to display, while the timing controller 402 should be operated in a lower voltage level to save power consumption. In such a situation, the level shifter 416 may shift the voltage level of the display data upward to be transmitted to the data conversion circuit 414 and the operational amplifier 410, and shift the voltage level of the image sensing data downward to be transmitted to the latch circuit 418 and the timing controller 402. The latch circuit 418, coupled to the level shifter 416 and the timing controller 402, is used for selectively storing the display data which are transmitted from the timing controller 402 and storing the image sensing data to be transmitted to the timing controller 402. More specifically, the latch circuit 418 may store the display data transmitted from the timing controller 402 when operating in the driver mode, and store the image sensing data to be transmitted to the timing controller 402 when operating in the readout mode.

The shift register 420, coupled to the latch circuit 418 and the timing controller 402, is used for controlling the latch circuit 418 according to a timing sequence from the timing controller 402 so that the latch circuit 418 may selectively receive the display data from the timing controller 402 and transmit the image sensing data to the timing controller 402. The timing controller 402 may control the operations of the shift registers 420 in the control units C_1-_N. In the driver mode, the timing controller 402 may in turn transmit the display data to the control units C_1-C_N, and configure the shift registers 420 in the control units C_1-C_N to control the latch circuit 418 to receive the display data in turn. The control units C_1-C_N then simultaneously output the display data to be displayed on a scan line. In the readout mode, the image sensing signals of a row of the pixel array may be received by the control units C_1-C_N and converted and stored in the latch circuit 418. The timing controller 402 may configure the shift registers 420 in the control units C_1-C_N to control the latch circuit 418 to output the image sensing data to the timing controller 402. In order to save the chip size, the transmissions of the display data and the image sensing data may share the same data bus. In other words, the control units C_1-C_N may receive the display data according to which the display signals are generated from the timing controller 402 and transmit the image sensing data which are generated according to the sensing signals to the timing controller 402 via the same data bus.

Please note that, according to the control signal(s) (not illustrated) generated by the timing controller 402, the control units C_1-C_N are controlled to selectively generate display signals and generate image sensing data. The panel is also configured to selectively perform display and perform image sensing. The panel may include a display area having a plurality of display pixels arranged in an array, where each display pixel has a circuit structure similar to the display pixel shown in FIG. 1, and is capable of receiving a display signal from a corresponding channel terminal among the channel terminals CH1-CHn. The panel may also include an image sensing area having a plurality of image sensing pixels arranged in an array and is capable of generating a sensing signal and transmitting the sensing signal to a corresponding channel terminal among the channel terminals CH1-CHn. The display area and the image sensing area may be deployed on the panel by any methods.

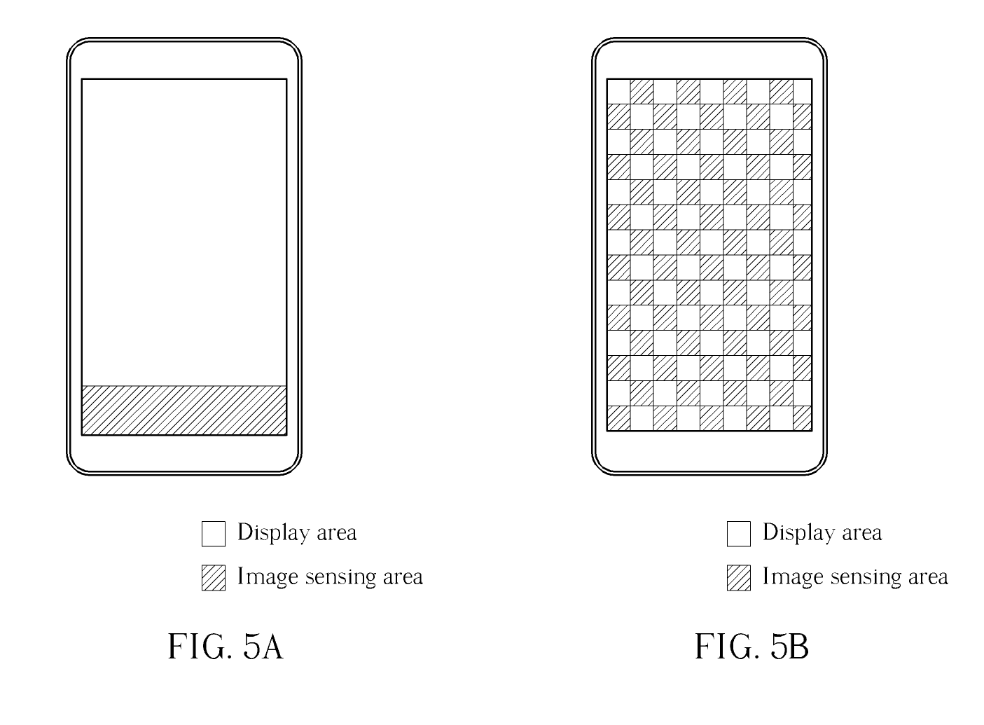

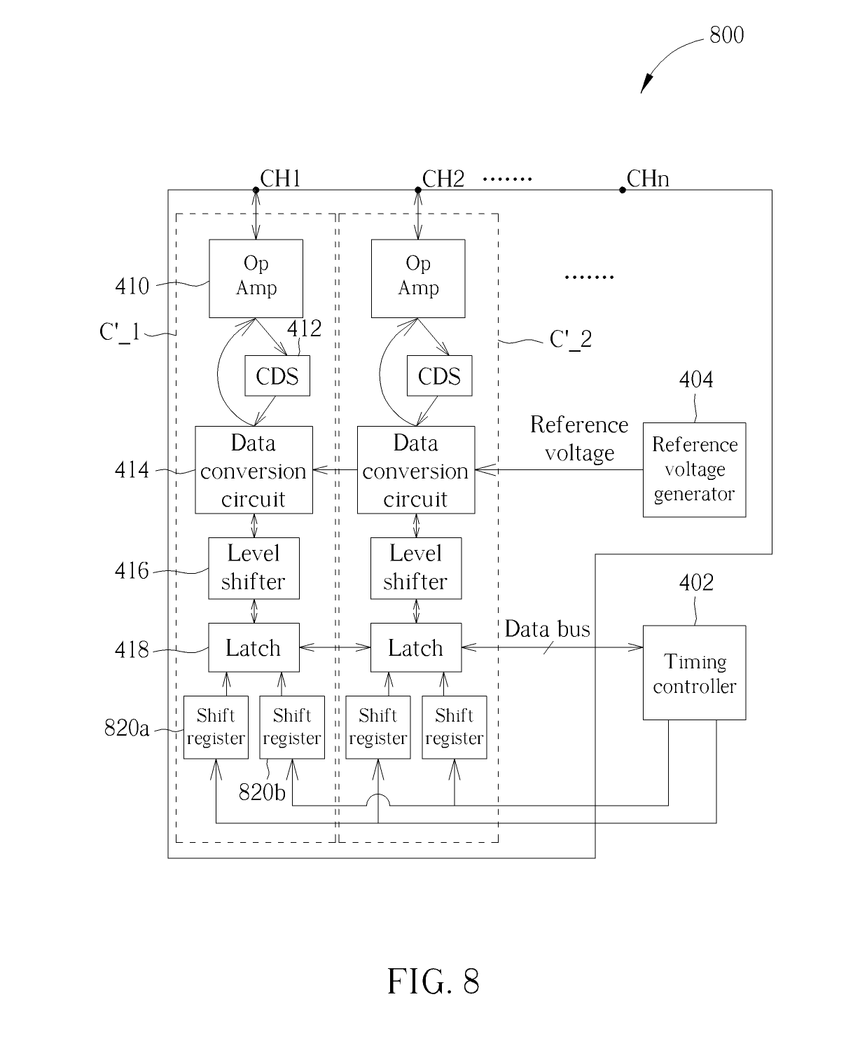

Please refer to FIG. 5A and FIG. 5B, which are diagrams of a deployment of display area and image sensing area for a mobile device according to embodiments of the present invention. In FIG. 5A, the mobile device has a panel in which most area is configured to be a display area and a small image sensing area is configured to be below the display area. The panel of FIG. 5A can be controlled by a control device such as the control device 400 of FIG. 4. In this embodiment, the image sensing area of FIG. 5A can be utilized as a fingerprint recognition device. In FIG. 5B, the mobile device has a panel in which display pixels and image sensing pixels are interlaced, like a checkerboard. In this embodiment, the entire panel where the image sensing pixels are distributed as in FIG. 5B can be utilized as a fingerprint recognition device. The panel of FIG. 5B can be controlled by a control device as illustrated in FIG. 8.

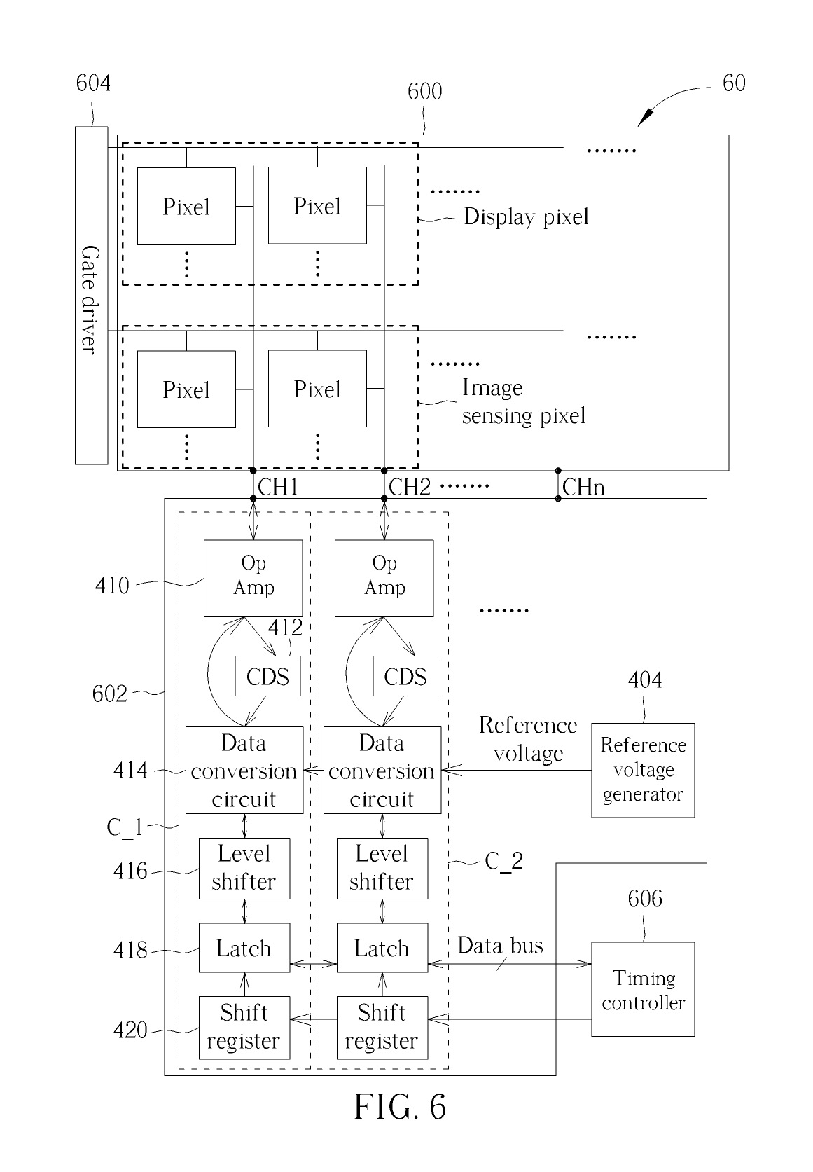

Please refer to FIG. 6, which is a schematic diagram of a display device 60 having image sensing and display functions according to an embodiment of the present invention, where the integrated control units and the related control device are applied. As shown in FIG. 6, the display device 60 includes a panel 600, a control device 602, a gate driver 604 and a timing controller 606. The panel 600 includes a plurality of display pixels disposed in the upper area and a plurality of image sensing pixels disposed in the lower area, which may look like the panel shown in FIG. 5A. The detailed structure of the display pixels is not limited to a specific type, and can be an LCD pixel as are illustrated in FIG. 1, or an OLED (Organic Light Emitting Diode) pixel, which are well known to those skilled in the art; the detailed structure of the image sensing pixels is not limited to a specific type, and can be optical (by using photodiodes), capacitive sensing, or piezoresistive sensing, which are well known to those skilled in the art and are not narrated herein.

The control device 602 includes a plurality of control units, which may include a circuit structure similar to the control units C_1-C_N shown in FIG. 4. The gate driver 604 is similar to the gate driver 104 of FIG. 1 and the row driver 204 of FIG. 2 and is used for turning on the display pixels and the image sensing pixels. Those skilled in the art should be able to derive the detailed operations of the display device 60 according to the above illustrations and descriptions, which will not be narrated herein.

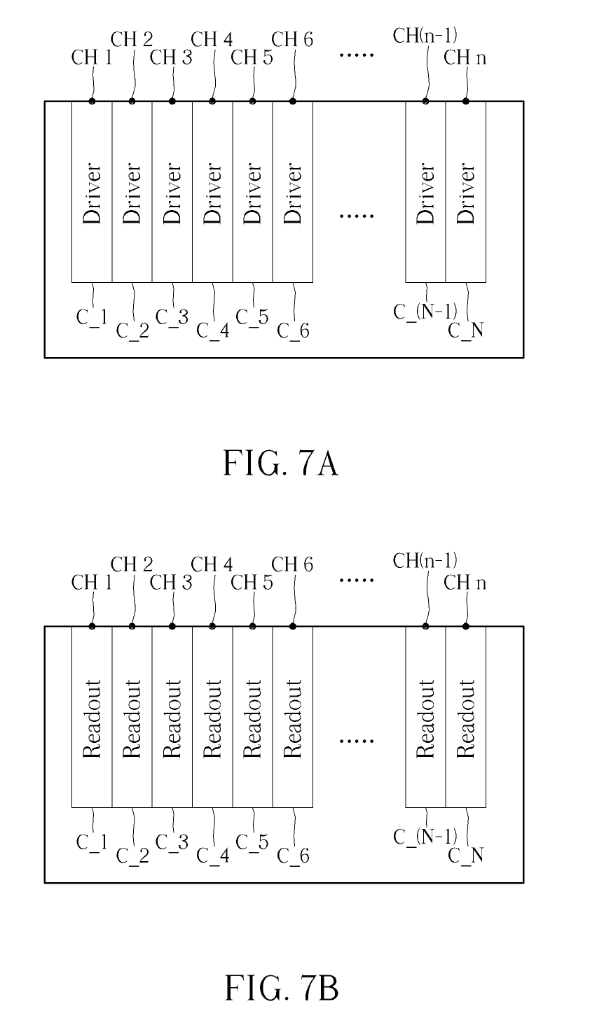

Further note that the timing controller 606 may respectively control the operation mode of each of the control units C_1-C_N. Please refer to FIGS. 7A and 7B, which are schematic diagrams of configurations of the operation modes of the control units C_1-C_N. As shown in FIG. 7A, all of the control units C_1-C_N operate in the driver mode. In this embodiment, the timing controller transmits the display data to all of the control units C_1-C_N, and the control units C_1-C_N transmit the display signals to be displayed to the panel via the channel terminals CH1-CHn. As shown in FIG. 7B, all of the control units C_1-C_N operate in the readout mode. In this embodiment, the control units C_1-C_N receive the sensing signals from the panel via the channel terminals CH1-CHn, and transmit the corresponding image sensing data to the timing controller. Based on the embodiment of FIG. 6, the control units C_1-C_N selectively operate in the driver mode as FIG. 7A and in the readout mode as FIG. 7B, at different period of time, and all of the control units C_1-C_N may be controlled by the timing controller via one control signal which indicates the operation mode. Alternatively, the timing controller may output N control signals to control the control units C_1-C_N, respectively, which can also result in the selective operation of the driver mode as FIG. 7A and the readout mode as FIG. 7B.

As mentioned above, the display and image sensing operations may share the same panel and also share the same channel terminals and control units in the control device, in order to save the chip cost and chip area. The control device 400 in FIG. 4 illustrates a device of sharing the control units, but this sharing device should not be a limitation of the present invention.

In another embodiment of the present invention, there may be several control units operating in the driver mode and other control units operating in the readout mode. The timing controller may respectively control the operation mode of each of the control units. For example, please refer to FIG. 8, which is a schematic diagram of another control device 800 according to an embodiment of the present invention. The control device 800 includes control units C′_1-C′_N and each of the control unit C′_1-C′_N is respectively controlled by the timing controller, so as to selectively operate in the driver mode and the readout mode. The circuit structure of the control device 800 is similar to that of the control device 400 of FIG. 4, so signals and elements with similar functions are denoted by the same symbols. A main difference between the control device 800 and the control device 400 is that each of the control units C′_1-C′_N in the control device 800 includes two shift registers 820a and 820b, where one shift register 820a is used for controlling the storage and transmission of display data and the other shift register 820b is used for controlling the storage and transmission of image sensing data. By using different shift registers for display data and for image sensing data, the timing controller 402 of FIG. 8 can control adjacent two control units to operate indifferent operation mode without conflict transmissions on data bus. With two shift registers respectively used in the driver mode and the readout mode, it is feasible to realize both of the display and image sensing operations on the same scan line (i.e., a row of pixel array), that is, to realize both of the display and image sensing operations simultaneously.

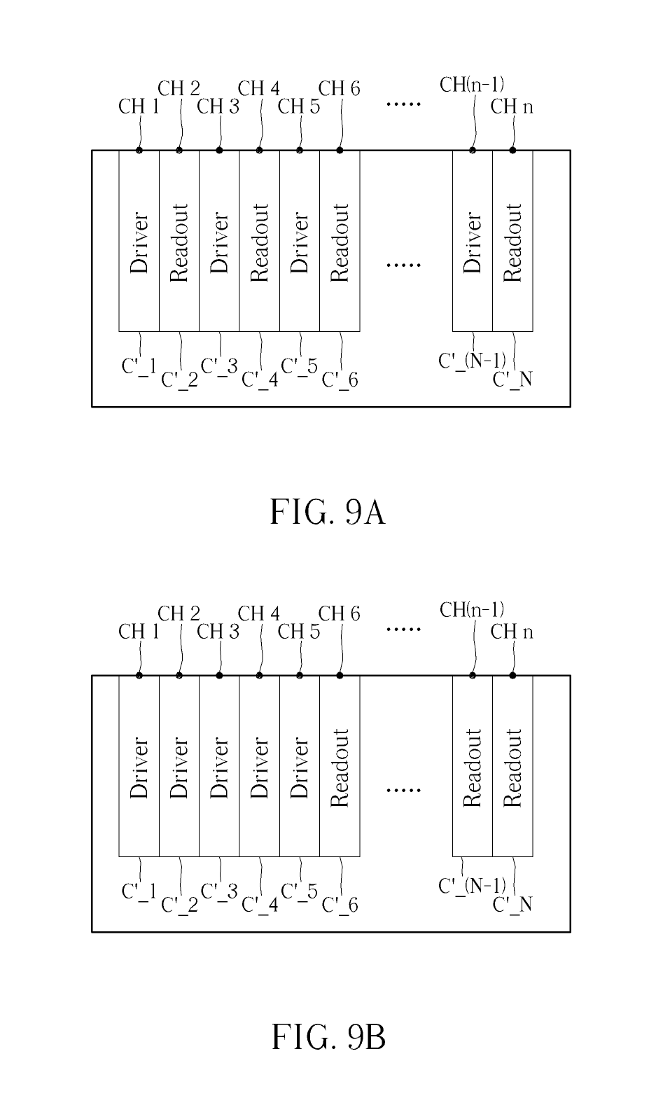

Please refer to FIGS. 9A and 9B, which are schematic diagrams of configurations of the operation modes of the control units C′_1-C′_N of the control device 800 of FIG. 8. As shown in FIG. 9A, the control units of the odd channels operate in the driver mode and the control units of the even channels operate in the readout mode. Based on the configurations of the operation modes of the control units C′_1-C′_N shown in FIG. 9A, the display area and image sensing area for a panel may present as shown in FIG. 5B. In another embodiment, as shown in FIG. 9B, the control units C′_1-C′_5 operate in the driver mode and the control units C′_6-C′_N operate in the readout mode.

Please note that according to the embodiments of the present invention, each component in the control units, such as the operational amplifier, the data conversion circuit, the level shifter, the latch circuit and the shift register, may or may not be integrated. Those skilled in the art may select to integrate any of these elements to operate in the driver mode and the readout mode; the integration method is not limited herein.

To sum up, the present invention provides a display device having display and sensing functions. The display device includes a panel and a control device for controlling the panel. The display and image sensing operations may share the same panel and the same channel terminals and control units in the control device, e.g., an integrated circuit. After the modification of the circuit structures in the readout circuit of an image sensing device, the readout unit may be combined with the source driver circuitry of the display device. The circuit elements in these control units such as the operational amplifier, the data conversion circuit, the level shifter, the latch circuit and the shift register may be shared and operated in both of the driver mode and the readout mode. Data buses for transmitting display data and image sensing data and reference voltages may also be shared. Therefore, the chip size and chip cost may be saved. With the integration of data display and image sensing functions, the panel of the display device may be used more efficiently and additional area for a fingerprint recognition device may be omitted. This benefits the mechanical design of the display device and thereby reduces the cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control device for a panel with display and sensing functions, comprising:
a plurality of channel terminals coupled to the panel; and
a plurality of control units, each being coupled to one of the plurality of channel terminals and being configured to selectively generate a display signal to be transmitted to the panel via the channel terminal and generate image sensing data based on a sensing signal received from the panel via the channel terminal.

2. The control device of claim 1, wherein the plurality of control units are controlled to selectively generate a plurality of display signals and generate a plurality of image sensing data according to at least one control signal generated by a timing controller.

3. The control device of claim 1, wherein during a first period, a plurality of display signals are transmitted to the panel via the plurality of channel terminals, and during a second period, a plurality of sensing signals are received from the panel via the plurality of channel terminals.

4. The control device of claim 3, wherein during the first period, the plurality of control units are configured to generate the plurality of display signals, and during the second period, the plurality of control units are configured to generate a plurality of image sensing data based on the plurality of sensing signals.

5. The control device of claim 1, wherein during a first period, a first display signal is transmitted to the panel via a first channel terminal of the plurality of channel terminals, and during a second period, a first sensing signal is received from the panel via the first channel terminal.

6. The control device of claim 5, wherein during the first period, a first control unit coupled to the first channel terminal is configured to generate the first display signal, and during the second period, the first control unit is configured to generate first image sensing data based on the first sensing signal.

7. The control device of claim 1, wherein each of the plurality of control units comprises:
a data conversion circuit having analog-to-digital conversion and digital-to-analog conversion functions, for selectively converting display data in digital form into the display signal in analog form and converting the sensing signal in analog form into the image sensing data in digital form.

8. The control device of claim 7, wherein each of the plurality of control units further comprises:
an operational amplifier, for selectively transmitting the display signal to drive the panel and transmitting the sensing signal from the panel;
a correlated double sampling (CDS) circuit, coupled to the operational amplifier and the data conversion circuit, for reducing noises in the sensing signal after receiving the sensing signal from the operational amplifier;
a level shifter, coupled to the data conversion circuit, for selectively shifting a voltage level of the display data and shifting a voltage level of the image sensing data;
a latch circuit, coupled to the level shifter and a timing controller, for selectively storing the display data which are transmitted from the timing controller and storing the image sensing data to be transmitted to the timing controller; and
a shift register, coupled to the latch circuit and the timing controller, for controlling the latch circuit according to a timing sequence from the timing controller so that the latch circuit selectively receives the display data from the timing controller and transmits the image sensing data to the timing controller.

9. The control device of claim 7, wherein the data conversion circuit receives the same reference voltages when operating analog-to-digital conversion and operating digital-to-analog conversion.

10. The control device of claim 1, wherein the plurality of control units receive a plurality of display data according to which a plurality of display signals are generated from a timing controller via a data bus, and transmit a plurality of image sensing data which are generated according to a plurality of sensing signals to the timing controller via the data bus.

11. A display device, comprising:
a panel, having display and sensing functions, for receiving a display signal and generating a sensing signal;
a control device, comprising:
a plurality of channel terminals, coupled to the panel; and
a plurality of control units, each being coupled to one of the plurality of channel terminals and being configured to selectively generate the display signal to be transmitted to the panel via the channel terminal and generate image sensing data based on the sensing signal received from the panel via the channel terminal.

12. The display device of claim 11, wherein the plurality of control units are controlled to selectively generate a plurality of display signals and generate a plurality of image sensing data according to at least one control signal generated by a timing controller.

13. The display device of claim 11, wherein during a first period, a plurality of display signals are transmitted to the panel via the plurality of channel terminals, and during a second period, a plurality of sensing signals are received from the panel via the plurality of channel terminals.

14. The display device of claim 13, wherein during the first period, the plurality of control units are configured to generate the plurality of display signals, and during the second period, the plurality of control units are configured to generate a plurality of image sensing data based on the plurality of sensing signals.

15. The display device of claim 11, wherein during a first period, a first display signal is transmitted to the panel via a first channel terminal of the plurality of channel terminals, and during a second period, a first sensing signal is received from the panel via the first channel terminal.

16. The display device of claim 15, wherein during the first period, a first control unit coupled to the first channel terminal is configured to generate the first display signal, and during the second period, the first control unit is configured to generate first image sensing data based on the first sensing signal.

17. The display device of claim 11, wherein each of the plurality of control units comprises:
a data conversion circuit having analog-to-digital conversion and digital-to-analog conversion functions, for selectively converting display data in digital form into the display signal in analog form and converting the sensing signal in analog form into the image sensing data in digital form.

18. The display device of claim 17, wherein each of the plurality of control units further comprises:
an operational amplifier, for selectively transmitting the display signal to drive the panel and transmitting the sensing signal from the panel;
a correlated double sampling (CDS) circuit, coupled to the operational amplifier and the data conversion circuit, for reducing noises in the sensing signal after receiving the sensing signal from the operational amplifier;
a level shifter, coupled to the data conversion circuit, for selectively shifting a voltage level of the display data and shifting a voltage level of the image sensing data;
a latch circuit, coupled to the level shifter and a timing controller, for selectively storing the display data which are transmitted from the timing controller and storing the image sensing data to be transmitted to the timing controller; and
a shift register, coupled to the latch circuit and the timing controller, for controlling the latch circuit according to a timing sequence from the timing controller so that the latch circuit selectively receives the display data from the timing controller and transmits the image sensing data to the timing controller.

19. The display device of claim 17, wherein the data conversion circuit receives the same reference voltages when operating analog-to-digital conversion and operating digital-to-analog conversion.

20. The display device of claim 11, wherein the plurality of control units receive a plurality of display data according to which a plurality of display signals are generated from a timing controller via a data bus, and transmit a plurality of image sensing data which are generated according to a plurality of sensing signals to the timing controller via the data bus.
